(19) United States
(12) Patent Application Publication
(10) Pub. No.: US 2017/0266076 A1
(43) Pub. Date: Sep. 21, 2017

(54) Massage Device

(71) Applicant: Shenzhen Pretty Love Technology Co., Ltd., Shenzhen (CN)

(72) Inventor: Xueliang CHEN, Liaoyang (CN)

(73) Assignee: Shenzhen Pretty Love Technology Co., Ltd.

(21) Appl. No.: 15/071,062

(22) Filed: Mar. 15, 2016

(51) Int. Cl. A61H 9/00; A61H 23/02

(52) U.S. Cl. CPC A61H 9/0057; A61H 23/02; A61H 2201/0157; A61H 2201/0169; A61H 2201/1207; A61H 2201/5025

(57) ABSTRACT

A massage device includes a main body, a vibrator, a control switch and a suction arrangement. The main body has a massaging portion, a handle portion, and a receiving cavity. The main body has an inwardly curved surface formed on the massaging portion. The vibrator is received in the receiving cavity at the massaging portion of the main body. The suction arrangement includes a guiding member and a suction pump. The guiding member is outwardly extended from the main body and has an air passage channel communicating the receiving cavity with ambient atmosphere. The suction pump is received in the receiving cavity for drawing air from the ambient atmosphere to the receiving cavity. The control switch is provided on the main body for selectively switching the vibrator and the suction pump.

### BACKGROUND OF THE INVENTION

Field of Invention

The present invention relates to a massage device, and more particularly to a message device which is capable of generating vibration and suction effect, and is extremely silent while being operated.

Description of Related Arts

A conventional massage device is usually in the form of massage chairs, massage balls or massage pillows. These conventional massage devices suffer the disadvantages that they are generally bulky in size, difficult or even impossible to carry, very noisy while being operated, and unsatisfactory massaging performance. Moreover, most of these conventional massage devices produce limited massaging effect because they can only produce vibrations.

As a result, there is a need to develop a massage device which is capable of producing a wide varieties of massaging effects while being silent while being operated.

### SUMMARY OF THE PRESENT INVENTION

Certain variations of the present invention is to provide a message device which is capable of generating vibration and suction effect, and is extremely silent while being operated.

Certain variations of the present invention is to provide a massage device which is portable and easy to use as compared to conventional massage devices.

In one aspect of the present invention, it provides a massage device, comprising:

a main body having a massaging portion, a handle portion, and a receiving cavity, the main body having an inwardly curved surface formed on the massaging portion;

a vibrator received in the receiving cavity at the massaging portion of the main body; and

a suction arrangement, which comprises:

a guiding member outwardly extended from the main body and has an air passage channel communicating the receiving cavity with ambient atmosphere; and

a suction pump received in the receiving cavity for drawing air from the ambient atmosphere to the receiving cavity; and

a control switch provided on the main body for selectively switching the vibrator and the suction pump, in such a manner when the vibrator and the suction pump are activated, the vibrator is arranged to generate a predetermined amount of vibration on the massaging portion of the main body, while the suction pump is arranged to draw air from the ambient atmosphere to the receiving cavity through the air passage channel.

### BRIEF DESCRIPTION OF THE DRAWINGS

FIG. 1 is a perspective view of a massage device according to a preferred embodiment of the present invention.

FIG. 2 is another perspective view of the massage device according to the preferred embodiment of the present invention.

FIG. 3 is a sectional schematic diagram of the massage device according to the preferred embodiment of the present invention.

FIG. 4 illustrates an alternative mode of the massage device according to the preferred embodiment of the present invention.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention. Each of the inventive features described below can be used independently of one another or in combination with other features.

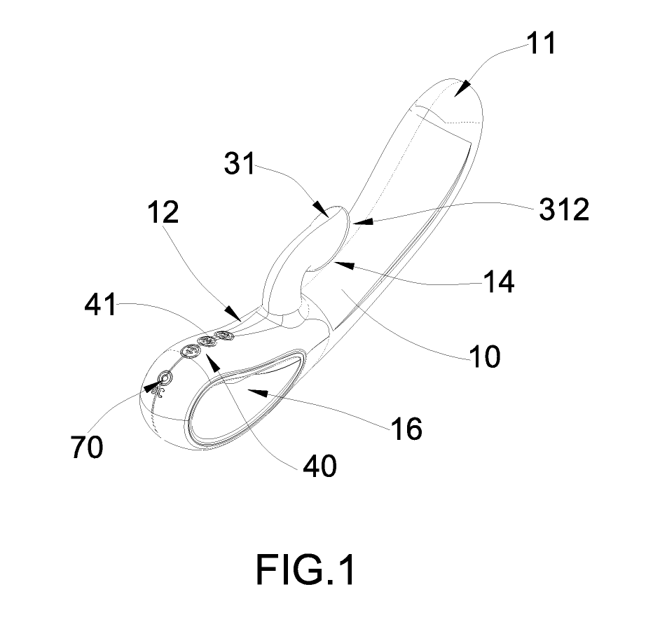

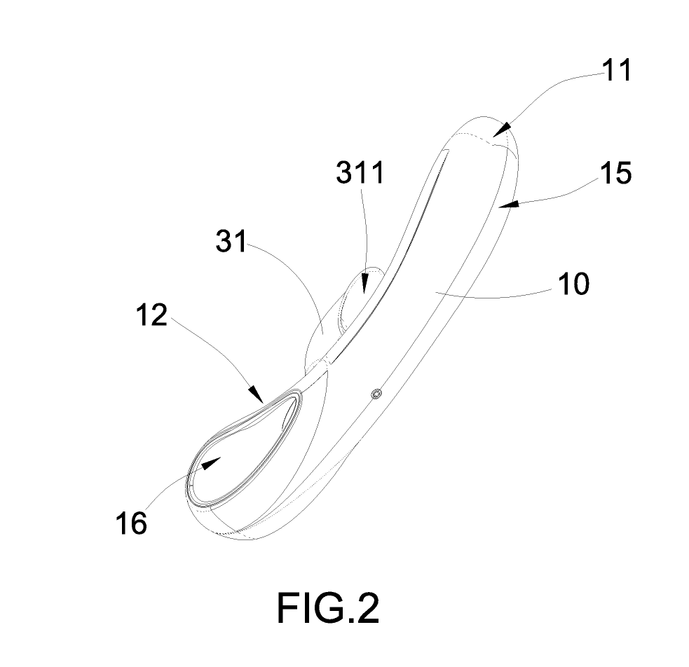

Referring to FIG. 1 to FIG. 2 of the drawings, a massage device according to a preferred embodiment of the present invention is illustrated. Broadly, the massage device may comprise a main body 10, a vibrator 20, a suction arrangement 30, and a control switch 40. The main body 10 may have a massaging portion 11, a handle portion 12, and a receiving cavity 13. Moreover, the main body 10 may have an inwardly curved surface 14 formed on the massaging portion 11.

The vibrator 20 may be received in the receiving cavity 13 at the massaging portion 11 of the main body 10.

The suction arrangement 30 may comprise a guiding member 31, and a suction pump 32. The guiding member 31 is outwardly extended from the main body 10 and has an air passage channel 311 communicating the receiving cavity 13 with ambient atmosphere. On the other hand, the suction pump 32 is received in the receiving cavity 13 for drawing air from the ambient atmosphere to the receiving cavity 13.

The control switch 40 is provided on the main body 10 for selectively switching the vibrator 20 and the suction pump 32, in such a manner when the vibrator 20 and the suction pump 32 are activated, the vibrator 20 is arranged to generate a predetermined amount of vibration on the massaging portion 11 of the main body 10, while the suction pump 32 is arranged to draw air from the ambient atmosphere to the receiving cavity 13 through the air passage channel 311.

According to the preferred embodiment of the present invention, the main body 10 of the massage device may be configured from soft material such as silicon rubber. The main body 10 may have an elongated structure and may be formed as having an arc-shaped contour, so that the massaging portion 11 has the inwardly and concavely curved surface 14. This inwardly and concavely curved surface 14 may be arranged to face the open end 312 of the air passage channel 311. Furthermore, the main body 10 may have a generally outwardly and convexly curved surface 15 which extends along the massaging portion 11 and the handle portion 12. As shown in FIG. 2 of the drawings, the massaging portion 11 and the handle portion 12 may be seamlessly and continuously connected with each other so as to form an integral structure of the main body 10. The overall contour of the main body 10 may be ergonomically designed so as to fit specific portions of a human body. The size of the massage device may be designed such that it may be conveniently portable.

The vibrator 20 may be arranged to controllably and adjustably generate vibrations at a designated frequency and magnitude. When the vibrator 20 is activated to produce vibrations, the vibrations may be transferred to the main body at the massaging portion 11 so as to generate corresponding vibrations on the massaging portion 11. The vibrations thus generated may carry out massage to specific positions on a human body when the massaging portion 11 is in contact with the human body, such as a human's lower back.

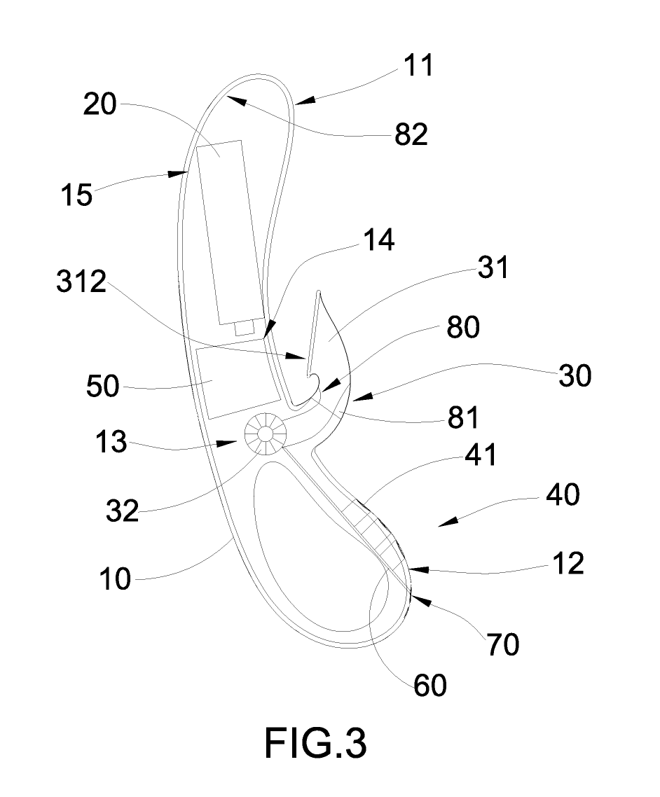

The guiding member 31 of the suction arrangement 30 may be extended from the main body 10 toward the inwardly and concavely curved surface 14. As shown in FIG. 1 and FIG. 3 of the drawings, the guiding member 31 may have a tubular structure and may have varying diameters along its longitudinal length. According to the preferred embodiment of the present invention, a diameter of the guiding member 31 may gradually increase from the main body 10 to the open end 312 of the guiding member 31. The air passage channel 311 may extend from the open end 312 to the suction pump 32 so that air may be drawn from the ambient atmosphere to the receiving cavity 13.

The control switch 40 may comprise at least one control button 41 provided on the handle portion 12 of the main body for allowing a user to control massaging parameters. The massage device may further comprise a rechargeable battery 50 received in the receiving cavity 13, and a Printed Circuit Board (PCB) 60 also received in the receiving cavity 13 and electrically connected to the rechargeable battery 50, the vibrator 20, the suction pump 32 and the control switch 40 for controlling an operation of these components so as to manage an overall operation of the massage device. The PCB 60 may be equipped with electrical components and Integrated Circuit (IC) chip.

The main body may further have a charging port 70 provided on the main body 10 and is electrically connected to the PCB 60. The charging port 70 may be configured for electrically connecting to an external power source so as to provide electrical energy to the rechargeable battery 50.

Furthermore, the massage device may further comprise a noise abatement arrangement 80 provided on the main body 10 for reducing noise when the massage device of the present invention is being operated. The noise abatement arrangement 80 may comprise a plurality of noise abatement panels 81 provided on an inner side surface of the guiding member 31 (i.e. in the air passage channel 311) for guiding a flow of air into and out of the suction pump 32, and a noise absorbing lining 82 provided in the receiving cavity 13 and covering an inner side surface of the receiving cavity 13. The noise absorbing lining 82 may be made of porous material which may be capable of absorbing a predetermined of sound waves generated inside the receiving cavity 13.

In order to facilitate easy gripping of the message device, the main body 10 may further have one through gripping slot 16 formed on the handle portion 12 at a transverse direction thereof. A user's hand may pass through the gripping slot 16 and securely grip on the handle portion 12 of the main body.

The operation of the present invention is as follows: a user may need to recharge the rechargeable battery 50 through plugging a specific adaptor to the charging port 70. After the rechargeable battery 50 has been charged, the user may operate on the control button 41 for switching on the massage device. The PCB 60 may drive the vibrator 20 and the suction pump 32 to operate. The suction pump 32 may operate in suction cycles to repetitively draw air from the open end 312 of the guiding member 31 to the receiving cavity 13. After a predetermined period of time, the air in the receiving cavity 13 may be guided to discharge out of the main body 13 through the open end 312. The air in the receiving cavity 13 may be pumped out of the receiving cavity 13 through operation of the suction pump 32. The frequency of the air suction cycles may be manually controlled by operating on the control button 41. Thus, ambient air is repetitively sucked into and discharged out from the receiving cavity 13 through the guiding member 31. The massage device of the present invention may be configured to be waterproof.

The noise abatement panels 81 provided on the guiding member 31 may be configured and positioned to allow smooth flow of air which passes through the air passage channel 311. This helps to reduce noise generated by flow of air in the air passage channel 311.

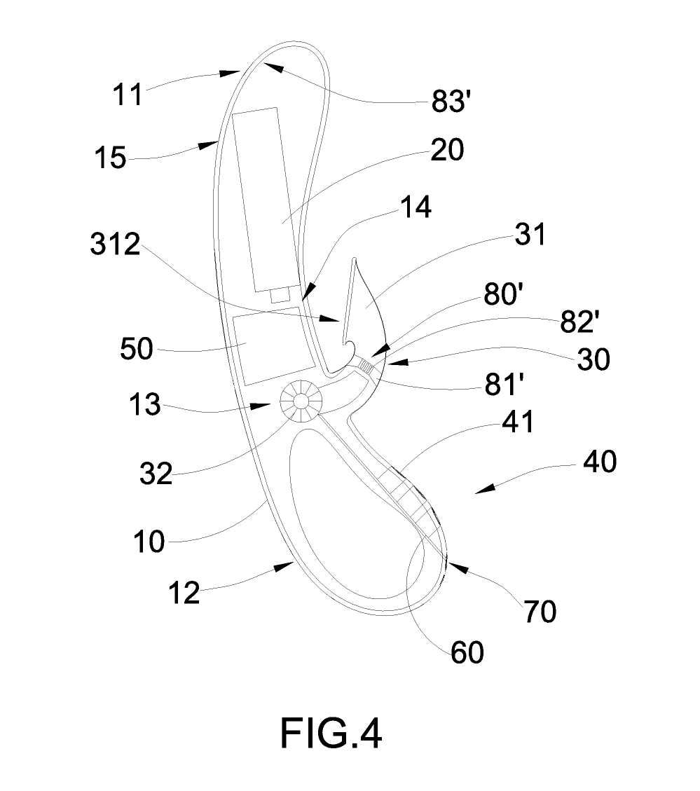

Referring to FIG. 4 of the drawings, an alternative mode of the massage device according to the preferred embodiment of the present invention is illustrated. The alternative mode is structurally similar to the preferred embodiment, except the noise abatement arrangement 80′. According to the alternative mode, the noise abatement arrangement 80′ may comprise a supporting housing 81′ provided on the inner side surface of the guiding member 31 (i.e. in the air passage channel 311), at least one noise absorption member 82′ supported in the supporting housing 81′ for absorbing noise, and a noise absorbing lining 83′ provided in the receiving cavity 13 and covering an inner side surface of the receiving cavity 13. The noise absorbing lining 83′ and the noise absorption member 82′ may be made of porous material which may be capable of absorbing a predetermined of sound waves generated by the suction pump 32 and by the flow of air in the air passage channel 311. Moreover, the supporting housing 81′ may be shaped to and sized to divide the air passage channel 311 into at least two flowing passageways so as to maximize noise absorption performance of the noise absorption member 82′.

The present invention, while illustrated and described in terms of a preferred embodiment and several alternatives, is not limited to the particular description contained in this specification. Additional alternative or equivalent components could be used to practice the present invention.

What is claimed is:

1. A massage device, comprising:
a main body having a massaging portion, a handle portion, and a receiving cavity, said main body having an inwardly and concavely curved surface formed on said massaging portion;
a vibrator received in said receiving cavity at said massaging portion of said main body; and
a suction arrangement, which comprises:
a guiding member outwardly extended from said main body and has an air passage channel communicating said receiving cavity with ambient atmosphere; and
a suction pump received in said receiving cavity for drawing air from said ambient atmosphere to said receiving cavity; and
a control switch provided on said main body for selectively switching said vibrator and said suction pump, in such a manner when said vibrator and said suction pump are activated, said vibrator is arranged to generate a predetermined amount of vibration on said massaging portion of said main body, while said suction pump is arranged to draw air from said ambient atmosphere to said receiving cavity through said air passage channel.

2. The massage device, as recited in claim 1, wherein said main body has an elongated structure and is formed as having an arc-shaped contour to form said inwardly and concavely curved surface, said inwardly and concavely curved surface being arranged to face said open end of said air passage channel.

3. The massage device, as recited in claim 1, wherein said guiding member has a tubular structure, a cross sectional diameter of said guiding member gradually increasing from said main body to said open end of said air passage channel which extends from said open end to said suction pump so that air is capable of being drawn from ambient atmosphere to said receiving cavity.

4. The massage device, as recited in claim 2, wherein said guiding member has a tubular structure, a cross sectional diameter of said guiding member gradually increasing from said main body to said open end of said air passage channel which extends from said open end to said suction pump so that air is capable of being drawn from ambient atmosphere to said receiving cavity

5. The massage device, as recited in claim 1, further comprising a noise abatement arrangement which comprises a plurality of noise abatement panels provided on an inner side surface of said guiding member for guiding a flow of air into and out of said suction pump, said noise abatement panels being positioned to allow smooth flow of air which passes through said air passage channel.

6. The massage device, as recited in claim 5, wherein said noise abatement arrangement further comprises a noise absorbing lining provided in said receiving cavity and covering an inner side surface of said receiving cavity, said noise absorbing lining being configured from porous material which may be capable of absorbing a predetermined of sound waves generated inside said receiving cavity.

7. The massage device, as recited in claim 1, wherein said noise abatement arrangement comprises a supporting housing provided on said inner side surface of said guiding member and at least one noise absorption member supported in said supporting housing for absorbing noise.

8. The massage device, as recited in claim 7, wherein said supporting housing is shaped to and sized to divide said air passage channel into at least two flowing passageways so as to maximize noise absorption performance of said noise absorption member.

9. The massage device, as recited in claim 8, wherein said noise abatement arrangement further comprises a noise absorbing lining provided in said receiving cavity and covering an inner side surface of said receiving cavity, said noise absorbing lining being configured from porous material which may be capable of absorbing a predetermined of sound waves generated inside said receiving cavity.

10. The massage device, as recited in claim 2, further comprising a printed circuit board received in said receiving cavity and electrically connected to said rechargeable battery, said vibrator, said suction pump, and said control switch for controlling and coordinating operations of said vibrator and said suction arrangement.

11. The massage device, as recited in claim 6, further comprising a printed circuit board received in said receiving cavity and electrically connected to said rechargeable battery, said vibrator, said suction pump, and said control switch for controlling and coordinating operations of said vibrator and said suction arrangement.

12. The massage device, as recited in claim 9, further comprising a printed circuit board received in said receiving cavity and electrically connected to said rechargeable battery, said vibrator, said suction pump, and said control switch for controlling and coordinating operations of said vibrator and said suction arrangement.

13. The massage device, as recited in claim 10, further comprising a rechargeable battery received in said receiving cavity and electrically connected to said printed circuit board for providing power to said vibrator and said suction arrangement, said main body further having a charging port provided on said main body and is electrically connected to said PCB, said charging port being configured for electrically connecting to an external power source to provide electrical energy to recharge said rechargeable battery.

14. The massage device, as recited in claim 11, further comprising a rechargeable battery received in said receiving cavity and electrically connected to said printed circuit board for providing power to said vibrator and said suction arrangement, said main body further having a charging port provided on said main body and is electrically connected to said PCB, said charging port being configured for electrically connecting to an external power source to provide electrical energy to recharge said rechargeable battery.

15. The massage device, as recited in claim 12, further comprising a rechargeable battery received in said receiving cavity and electrically connected to said printed circuit board for providing power to said vibrator and said suction arrangement, said main body further having a charging port provided on said main body and is electrically connected to said PCB, said charging port being configured for electrically connecting to an external power source to provide electrical energy to recharge said rechargeable battery.

16. The massage device, as recited in claim 2, wherein said main body further has a through gripping slot formed on said handle portion at a transverse direction thereof.

17. The massage device, as recited in claim 12, wherein said main body further has a through gripping slot formed on said handle portion at a transverse direction thereof.

18. The massage device, as recited in claim 15, wherein said main body further has a through gripping slot formed on said handle portion at a transverse direction thereof.

19. The massage device, as recited in claim 2, wherein said main body is made of silicon rubber.

20. The massage device, as recited in claim 18, wherein said main body is made of silicon rubber.
